(19) United States
(12) Patent Application Publication
(10) Pub. No.: US 2017/0114928 A1
(43) Pub. Date: Apr. 27, 2017

(54) ORGANIZING DEVICE FOR CABLE AND WIRE

(71) Applicant: Wanho T Manufacturing Co., Ltd., Ilan (TW)

(72) Inventors: Christopher Pierre CROUNSE, Florence, AZ (US); Arthur C. GAGNON, Wolcott, CT (US)

(21) Appl. No.: 14/919,770

(22) Filed: Oct. 22, 2015

(51) Int. Cl. F16L 3/10; F16L 3/23; F16L 3/237; F16L 3/223

(52) U.S. Cl. CPC F16L 3/1058; F16L 3/1091; F16L 3/2235; F16L 3/23; F16L 3/237

(57) ABSTRACT

An organizing device includes two casing members each having a recess, and the recesses of the casing members are directed toward each other for receiving a cable, and the casing members each include one or more spring blades located in front of the recess of the casing member for engaging with the cable and for retaining the cable in the recesses of the casing members with the spring blades. The casing members each include one or more projections extended from the spring blades for frictionally engaging with the cable. The casing members each include an orifice for engaging with a fastener.

### BACKGROUND OF THE INVENTION

1. Field of the Invention

The present invention relates to an organizing device, and more particularly to a cable and wire organizing device including a structure or configuration for allowing the cables and the wires to be easily and quickly engaged into the organizing device and to be easily and quickly attached or mounted or secured to various supporting facilities with the organizing device.

2. Description of the Prior Art

Typical cable organizing devices comprise a back mounting block for attaching or mounting or securing to various supporting apparatuses or facilities, the back mounting block includes a number of slots formed therein for receiving or engaging with the cables and the wires, and a front cap attached or mounted or secured to the back mounting block for clamping and retaining the cables and the wires between the back mounting block and the front cap.

For example, U.S. Pat, No. 4,330,005 to Kjarsgaard, U.S. Pat. No. 4,715,571 to Soltow et al., U.S. Pat. No. 5,167,388 to Blair, U.S. Pat. No. 5,443,232 to Kesinger et al., U.S. Pat. No. 5,742,982 to Dodd et al., U.S. Pat. No. 5,816,736 to Kroulik, U.S. Pat. No. 6,462,275 to Daud, U.S. Pat. No. 6,736,669 to Martin et al., and U.S. Pat. No. 7,607,618 to Mori et al. disclose several of the typical cable organizing devices each comprising a front part and a rear part including a number of slots formed therein for receiving or engaging with the cables and the wires, and a bracket attached or mounted or secured to the rear part for clamping and retaining the cables and the wires between the bracket and the rear part.

However, the front caps and the brackets should be removed and separated from the back mounting blocks and the rear parts before the cables and the wires may be disposed or attached or engaged into the slots that are formed between the back mounting block and the front cap or between the bracket and the rear part. In addition, the typical cable organizing devices may not stably anchor and retain the cables and the wires of different sizes or diameters or dimensions to the typical cable organizing devices, and the cables and the wires may have a good chance to be disengaged from the typical cable organizing devices.

The present invention has arisen to mitigate and/or obviate the afore-described disadvantages of the conventional cable and wire organizing devices.

### SUMMARY OF THE INVENTION

The primary objective of the present invention is to provide a cable organizing device including a structure or configuration for allowing the cables and the wires to be easily and quickly engaged into the organizing device and to be easily and quickly attached or mounted or secured to various supporting facilities with the organizing device.

The othery objective of the present invention is to provide a cable organizing device including a structure or configuration for easily and quickly engaging with the cables and the wires of different dimensions or diameters and for allowing the cables and the wires of different dimensions or diameters to be easily and quickly attached or mounted to the organizing device with spring blades.

In accordance with one aspect of the invention, there is provided an organizing device comprising two casing members each including a recess formed therein, the recesses of the casing members being directed toward each other for receiving a cable, and the casing members each including at least one spring blade extended therefrom and located in front of the recess of the casing member for engaging with the cable and for solidly and stably retaining the cable in the recesses of the casing members with the elastic force of the spring blade.

The casing members each include at least one projection extended from the spring blade for frictionally engaging with the cable and for solidly and stably retaining the cable in the recesses of the casing members. The casing members each include an orifice formed therein, and the orifices of the casing members are aligned with each other for engaging with a fastener which may solidly secure the casing members together, and/or to the other supporting members.

The casing members include one or more holes formed therein, and the other casing member may include a key or peg extended therefrom for engaging with the hole of the casing member and for anchoring and retaining the casing members together and for preventing the casing members from shifting or moving up and down relative to each other. The casing members each include a plurality of recesses or cavities formed therein for weight reducing purposes.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a partial exploded view illustrating the operation of a cable organizing device in accordance with the present invention;

FIG. 2 is a cross sectional view illustrating the operation of the cable organizing device;

FIG. 3 is a partial cross sectional view illustrating the operation of the cable organizing device;

FIG. 4 is an enlarged partial cross sectional view of the cable organizing device; and

FIGS. 5, 6, 7, 8 are cross sectional views similar to FIG. 2, illustrating the operation of the cable organizing device.

### DETAILED DESCRIPTION OF THE PREFERRED EMBODIMENT

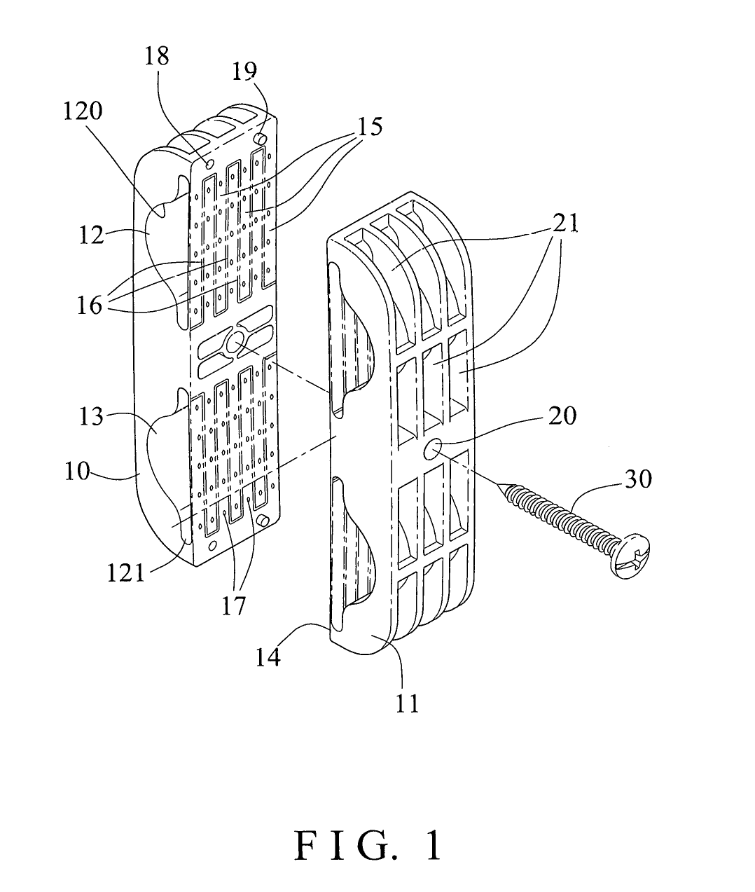

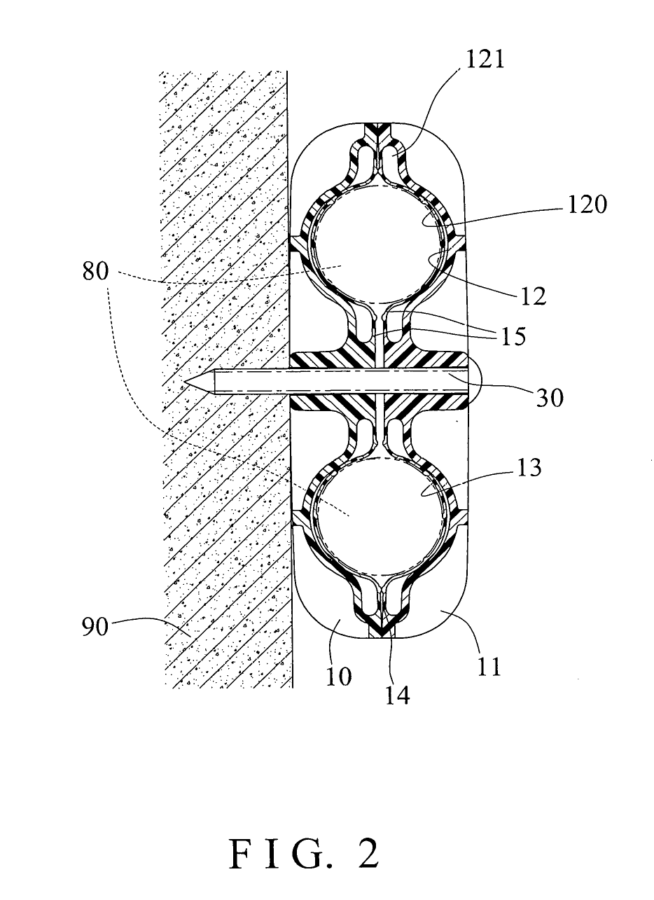

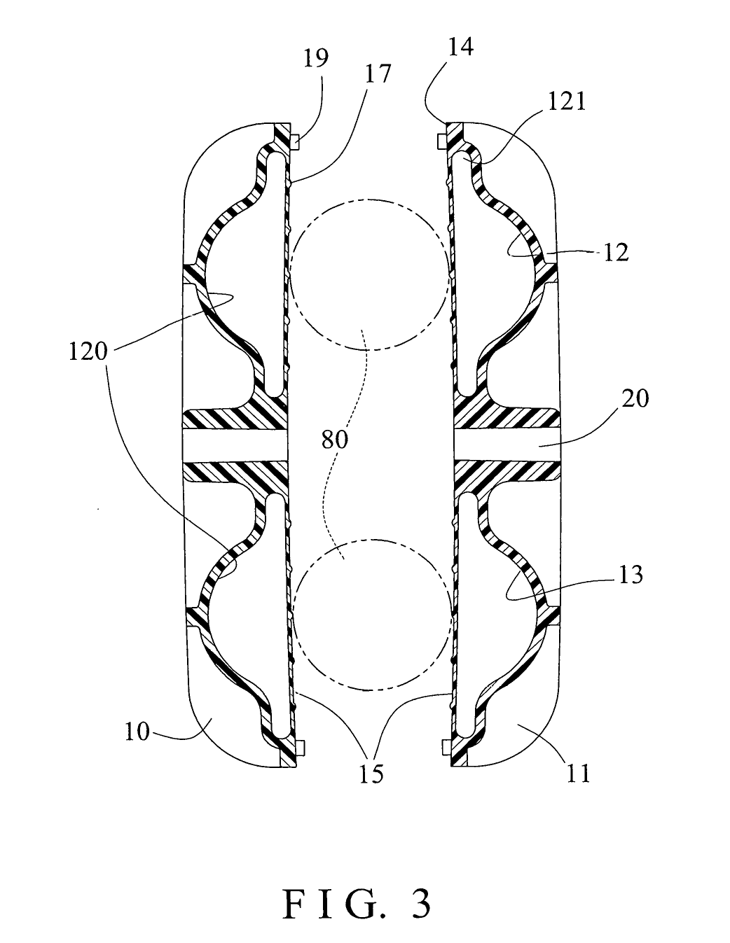

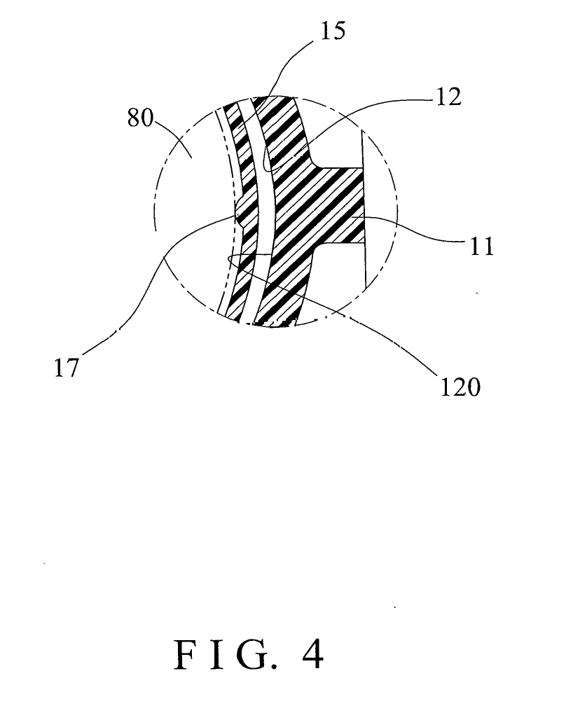

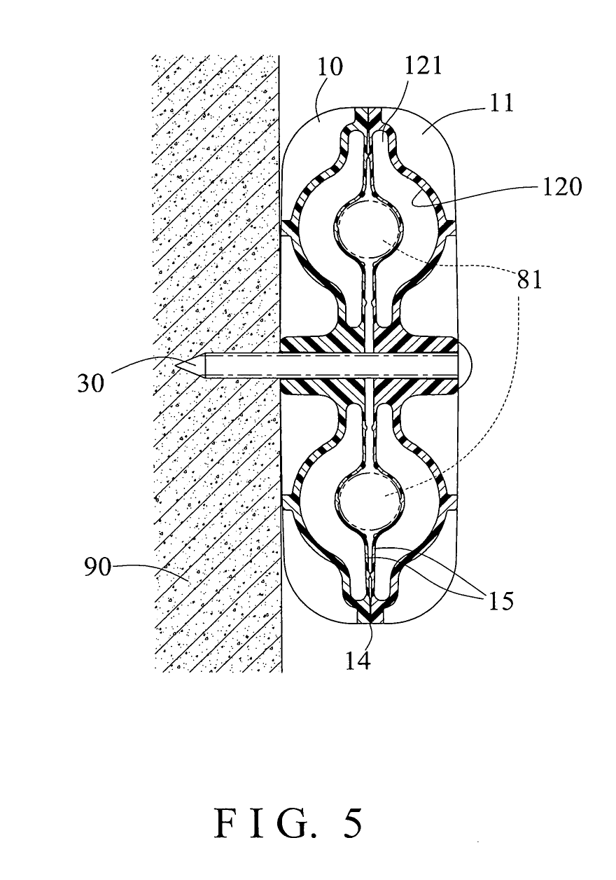

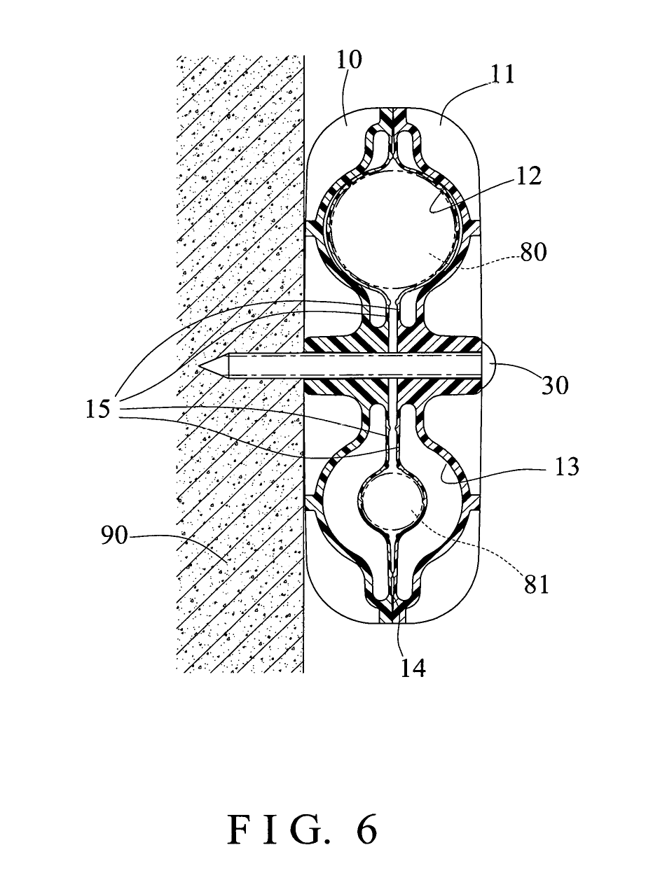

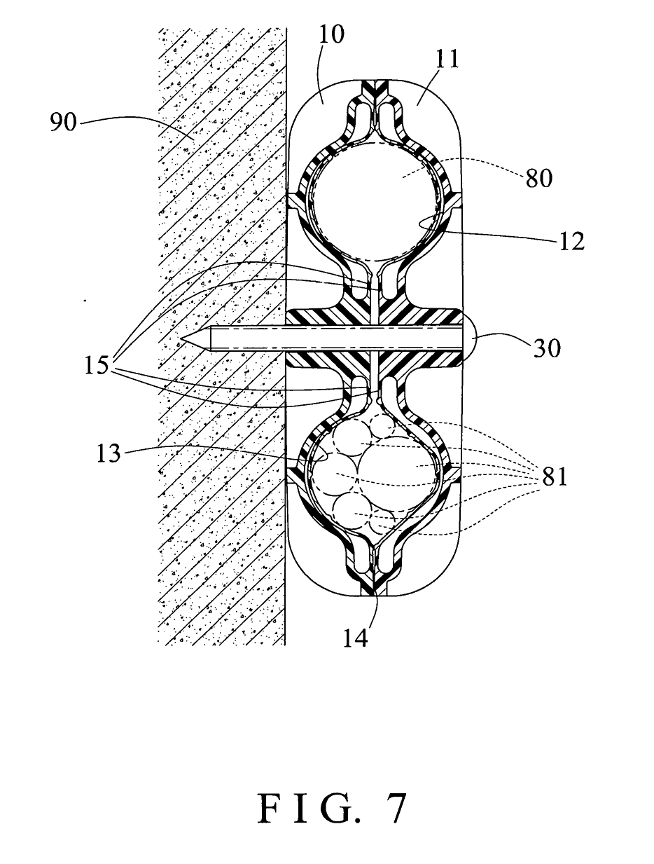

Referring to the drawings, and initially to FIGS. 1-3, a cable organizing device in accordance with the present invention comprises two casing members 10, 11 mirror symmetric to each other, or including a mirror symmetric structure, the casing members 10, 11 each include one or more (such as two) depressions or recesses 12, 13 formed therein, such as formed in the inner portion 14 thereof and separated or spaced from each other for receiving or engaging with the cables 80 and/or the wires 81 (FIGS. 2-8), for example, the recesses 12, 13 at the inner portions 14 of the casing members 10, 11 are faced or directed toward each other for forming or defining an inner diameter greater than that of the cables 80 and the wires 81 and thus for allowing the cables 80 and the wires 81 of different dimensions or sizes or shapes or contours or standards or diameters to be suitably received or engaged in the recesses 12, 13 of the casing members 10, 11.

The casing members 10, 11 each further include one or more or a number of bars or spring blades 15 extended or provided in the inner portions 14 of the casing members 10, 11 and/or located in front of the recesses 12, 13 of the casing members 10, 11 respectively for contacting or engaging with the cables 80 and/or wires 81 and for allowing the cables 80 and the wires 81 of different dimensions or sizes or shapes or contours or standards or diameters to be suitably clamped and anchored or retained in the recesses 12, 13 of the casing members 10, 11 with the spring blades 15 (FIGS. 2, 5-8). The spring blades 15 are suitably separated or spaced from each other with slots or grooves 16 (FIG. 1). It is preferable that the spring blades 15 each include a number of protrusions or projections 17 extended therefrom (FIGS. 1, 3, 4) for frictionally contacting or engaging with the cables 80 and/or wires 81. The casing members 10, 11 each may include one or more cavities 21 formed therein for weight reducing purposes.

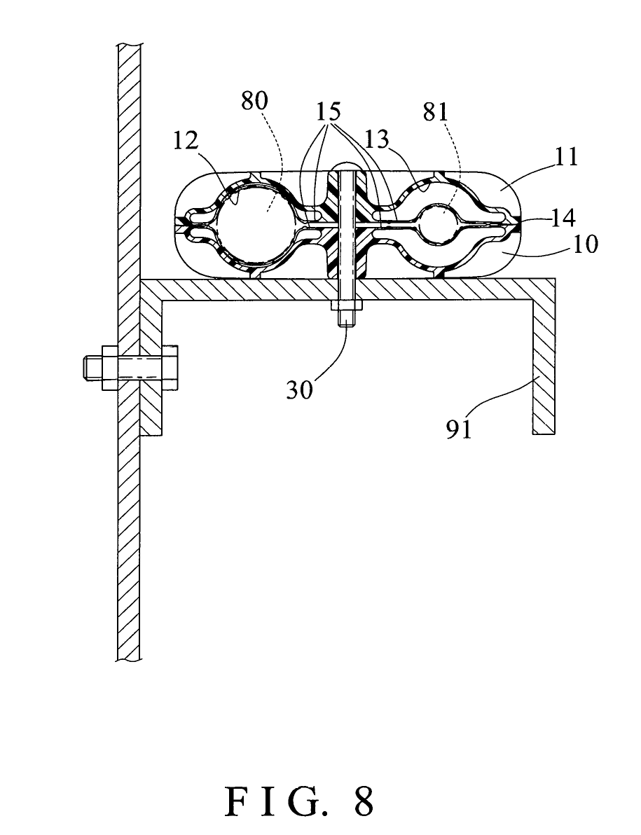

The casing members 10, 11 each further include one or more holes 18 formed therein, and one or more keys or pegs 19 extended therefrom (FIG. 1), and the pegs 19 of the casing members 10, 11 may be engaged with the holes 18 of the other casing members 11, 10 for anchoring or retaining or positioning the casing members 10, 11 together and for preventing the casing members 10, 11 from moving or shifting up and down and laterally relative to each other. The casing members 10, 11 each further include an orifice 20 formed therein, and the orifices 20 of the casing members 10, 11 are aligned with each other for receiving or engaging with a fastener 30 which may secure or retain or position the casing members 10, 11 together and/or which may secure or attach or mount the casing members 10, 11 to any suitable supporting elements 90, 91, such as the wall member 90 (FIGS. 2, 5-7), or the bracket 91 (FIG. 8) or the like.

In operation, as shown in FIGS. 2 and 5-8, the cables 80 and the wires 81 of different dimensions or sizes or shapes or contours or standards or diameters may be suitably received or engaged in the recesses 12, 13 of the casing members 10, 11 and may be suitably and resiliently clamped and anchored or retained in the recesses 12, 13 of the casing members 10, 11 with the spring blades 15.

Accordingly, the cable organizing device includes a structure or configuration for allowing the cables and the wires to be easily and quickly engaged into the organizing device and to be easily and quickly attached or mounted or secured to various supporting facilities with the organizing device, and for allowing the cables and the wires of different dimensions or diameters to be easily and quickly attached to the organizing device with spring blades.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

1. An organizing device comprising:
two casing members each including a recess formed therein and defined by a base surface and an opening, said recesses of said casing members being directed toward each other for receiving a cable, and
said casing members each including at least one spring blade extended therefrom and located in front of said recess of said casing member at said opening of said casing member and separated from said base surface of said casing member for engaging with said cable and for retaining said cable in said recesses of said casing mcmbcis with said at least one spring blade.

2. The organizing device as claimed in claim 1, wherein said casing members each include at least one projection extended from said at least one spring blade for engaging with said cable.

3. The organizing device as claimed in claim 1, wherein said casing members each include an orifice formed therein, and said orifices of said casing members are aligned with each other for engaging with a fastener.

4. The organizing device as claimed in claim 1, wherein one of said casing members include a hole formed therein, and the other casing member include a peg extended therefrom for engaging with said hole of said casing member and for anchoring and retaining said casing members together.

5. The organizing device as claimed in claim 1, wherein said casing members each include a plurality of cavities formed therein.
